(19) United States
(12) Patent Application Publication
(10) Pub. No.: US 2017/0323081 A1
(43) Pub. Date: Nov. 9, 2017

(54) GRAPHICAL USER INTERFACES RECOMMENDING CARE

(71) Applicant: Sphere3, LLC, Kansas City, KS (US)

(72) Inventors: Kourtney Govro, Raymore, MO (US); Rodney Corn, Anthem, AZ (US); Kristal Rayson, Independence, MO (US); Steven Kent Mills, Overland Park, KS (US)

(21) Appl. No.: 15/585,421

(22) Filed: May 3, 2017

Related U.S. Application Data
(60) Provisional application No. 62/331,059, filed on May 3, 2016.

(51) Int. Cl. G06F 19/00; G06F 3/0482

(52) U.S. Cl. CPC G06F 19/363; G06F 3/0482

(57) ABSTRACT

Media, method, and system are described for generating a graphical user interface reflecting patient experience data. Particularly, embodiments describe behavior and satisfaction data from a hospital used to generate a prioritized task list graphical user interface. The graphical user interface may be presented at a separate location of care from the location at which behavior data was recorded.

### RELATED APPLICATIONS

This non-provisional patent application claims priority benefit, with regard to all common subject matter, of earlier-filed U.S. Provisional Patent Application No. 62/331,059, filed May 3, 2016, and entitled SYSTEMS AND METHODS OF MODELING PATIENT BEHAVIORS TO PREDICT AND INCREASE SATISFACTION. The identified earlier-filed provisional patent application is hereby incorporated by reference in its entirety into the present application.

This non-provisional patent application discloses subject matter that integrates with subject matter disclosed in U.S. patent application Ser. No. 13/795,501, filed Mar. 12, 2013, and entitled SYSTEMS AND MODULES FOR IMPROVING PATIENT SATISFACTION. The identified earlier-filed patent application is hereby incorporated by reference in its entirety into the present application.

### BACKGROUND

### 1. Field

Embodiments of the invention are broadly directed to methods and systems for generating graphical user interfaces recommending tasks to care providers, such as nurses or physicians. Specifically, embodiments of the invention draw experience data from a record containing patient experience data recorded at a hospital to present a prioritized task list to a provider at care facilities and other locations that may not otherwise share data with the original data-collecting care facility.

### 2. Related Art

Traditionally, access to a patient experience record is often restricted to the locations at which the care was documented. When a patient transfers from a first location of care, the time and effort invested in improving care for that patient based on documented experiences, preferences, behaviors, and feedback are often lost. Recapture of this patient experience data often leads to additional frustration and discomfort from a patient that is detrimental to improving the patient's health.

Patient care and satisfaction can be improved when patient experience records can be shared across all locations, establishments, departments, and facilities that provide care to a particular patient. Further, patient experience record sharing increases patient safety, reduces errors, and saves valuable time when the need to redocument information is obviated.

As a result of the typical “reset” of patient experience data whenever a patient transfers from one location of care to another, high satisfaction scores from a patient regarding care provided at the new location of care are often difficult or impossible to achieve. Decreased satisfaction may lead to poor reviews and ultimately reduced income for care locations that lack access to previously documented patient experience records. Accordingly, there is a need for improved systems and methodologies to generate graphical user interfaces recommending tasks to care providers, such as nurses or physicians at a care location based on experience and satisfaction data that may have been recorded at a previous care location, such as a hospital.

### SUMMARY

Embodiments of the invention address this need by generating graphical user interfaces a locations of care that present patient tasks to a care provider based on previously documented patient experience data. Embodiments of the invention may further include steps of generating the list of tasks based on a plurality of experience and/or care records, prioritizing these tasks based on patient experience data, and presenting them to a provider in a manner indicating urgency or motivation. Embodiments of the invention include various systems and methods for generating, correlating, and presenting graphical user interfaces using patient experience data at a location distinct from the location at which the data was recorded.

In a first embodiment, a method of managing patient experience data generates a graphical user interface configured to display a recommended list of tasks for a provider at a first location of care. The list of tasks includes a care task to be performed for a first patient, and is generated based, at least in part, on patient experience data stored in a patient experience record associated with the patient. Particularly, the patient experience data may be recorded at a second location of care, which is distinct from the first location of care, and may be presented in a prioritized order for care. The graphical user interface including a recommended list of tasks may be adjusted based on newly collected data, such as satisfaction scores.

In a second embodiment, a method of managing patient experience data begins with recording of patient experience data in a patient experience record on a server from a first location of care, such as a hospital. The patient experience record is then transmitted to a second location of care at which the patient is or will be treated.

Next, a recommended list of tasks for completion by a provider at the second location of care is produced based, at least in part, on the patient experience record. Finally, a graphical user interface based on the patient experience record is generated for display to the provider. The recommended list of tasks may further be based on care data from the first location of care or a third location of care.

In a third embodiment, a system for managing patient experience data includes a computer terminal including a processor, a network interface card, and a non-transitory computer readable medium. The computer readable medium stores computer-executable instructions directing the processor to perform the steps of generating a population of patients and retrieving a set of experience records for the patients in the population. Thereafter, the instructions direct the processor to produce a list of tasks for the population and prioritize those tasks based at least in part on the experience records. Finally, the system generates a graphical user interface for the prioritized task list and displays it to a provider of care. The prioritized list may be updated in response to new patients added to the population and/or new experience data added to a patient's record.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts an example of an graphical user interface that may be presented on a display in embodiments of the invention;

FIG. 3 depicts storage and sharing of patient care records across multiple patient care locations;

FIG. 4 depicts a first flowchart illustrating the operation of a method in accordance with an embodiment of the invention;

FIG. 5 depicts a second flowchart illustrating the operation of a method in accordance with an embodiment of the invention;

FIG. 6 depicts a third flowchart illustrating the operation of a method in accordance with an embodiment of the invention; and

FIG. 7 depicts a fourth flowchart illustrating the operation of a method in accordance with an embodiment of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

Embodiments of the invention are directed to systems and methods for generating a graphical user interface based, at least in part, on patient experience data. Patient experience data may include information not typically stored in an EMR, such as satisfaction scores of patients, preferences on daily routines, notes on care from nurses, and personal favorites of patients, such as foods or television programs. Embodiments may store and/or update patient experience data in patient experience records stored in a communicatively coupled server. Embodiments of the invention may further produce valuable tools for improving patient care and satisfaction such as trend maps, priority hierarchies, hot sheets, trigger levels, and compliance scores for inclusion in a patient experience record. These examples are not intended as limiting. Any data relevant to prior, current, or future care and satisfaction of a patient may be included as patient experience data in embodiments of the invention.

Generally, the longer a patient remains in the care of a particular set of care providers at a particular location of care, the more comfortable and more satisfied the patient becomes. Often, the improved comfort and/or satisfaction of the patient is a result of observations gleaned over time by particular set of providers correlating patient behaviors and responses with details medical care data, such as timing, style, or order of care. As the patient/provider relationship grows, improvements in satisfaction lead to improvements in health, while improvements in health lead to improvements in satisfaction.

Unfortunately, the valuable insights established during the patient's encounter at the particular location of care with the particular set of care providers are often lost when the patient transfers to another location, such as another hospital, a long term nursing facility, or to the patient's residence. The quality of further care received at any of these locations and/or an outpatient clinic drops back to the level of care received when the patient first arrived at the first hospital, often causing frustration or dissatisfaction that the patient's peculiarities, preferences, and routines must be relearned by the new set of care providers. In short, the patient returns to square one every time they transfer. What is needed is a continuity of recorded, recognized, or derived behavioral, satisfaction, and experience data that brings the quality of care received at a new location of care to the level of that received at a place the patient has been visiting their entire life.

Embodiments of the invention first address these issues by storing, transmitting, and receiving behavioral, experience, and satisfaction data at a location of care recorded at a previous, distinct location of care for generation and presentation of a graphical user interface recommending tasks to a care provider. This description is intended as an example of embodiments of the invention, and is not intended to be limiting. Embodiments of the invention may be applied in any situation in which records need to be retrieved and shared between locations accurately and securely.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

### Operational Environment for Embodiments of the Invention

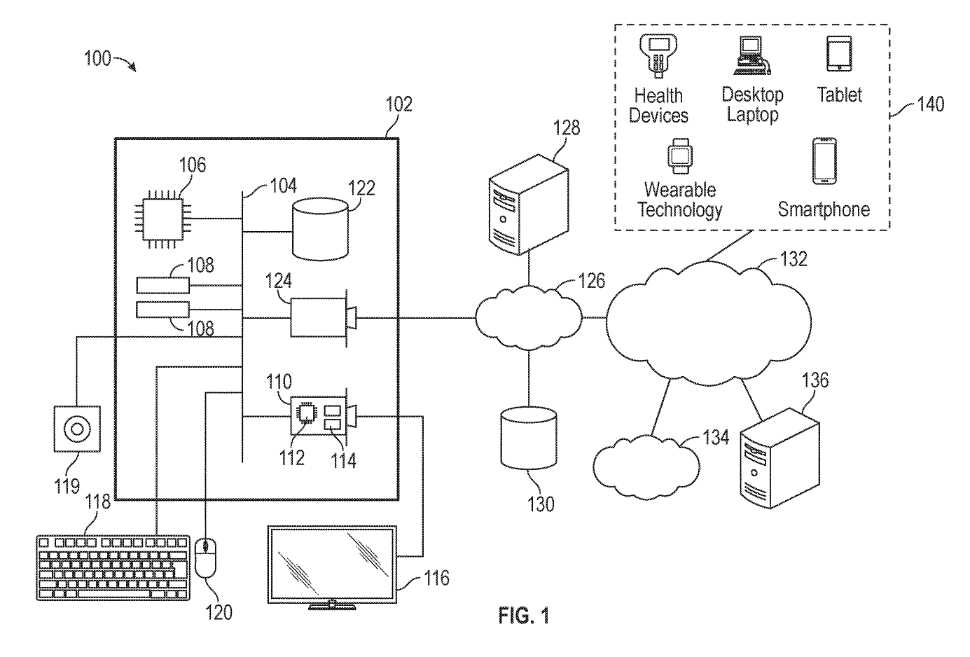

Turning first to FIG. 1, an exemplary hardware platform that can form one element of certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118, indicium receiver 119, and mouse 120 are connected to system bus 104. Like display 116, these peripherals may be integrated into computer 102 or absent. In some embodiments, indicium receiver 119 may be a digital camera, barcode reader, or hardware supporting short-range wireless communication such as RFID, Bluetooth, or infrared (IR) beam communication. Also connected to system bus 104 is local storage 122, which may be any form of computer-readable media, and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as server 130.

Generally, a data store such as server 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Server 130 should not be strictly viewed as a single server at a singly physical location, but rather may be comprised of a plurality of data storage servers that may be located at multiple, remote locations.

Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132. Through connection 132, the system may be communicatively coupled to devices, wearables, appliances, facility structures, and other electronic experience documentation devices, represented in FIG. 1 by element 140.

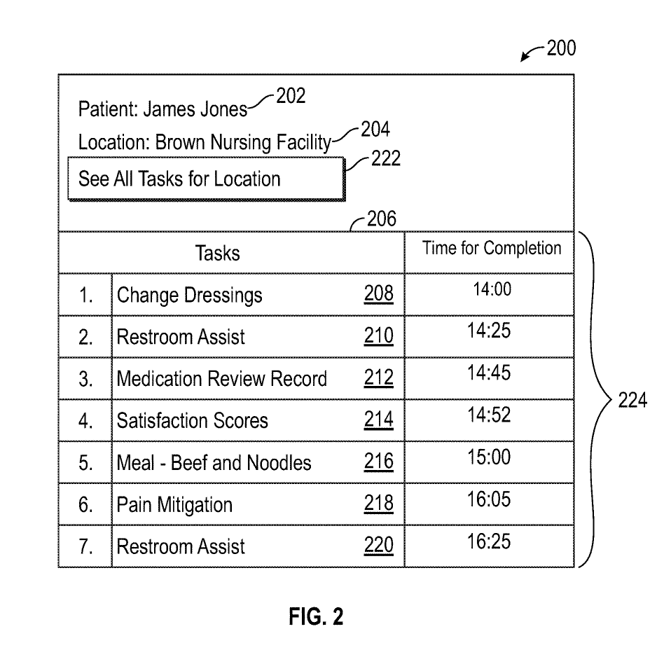

Embodiments of the invention include systems and methods of generating graphical user interfaces comprising a prioritized list of tasks for completion by a provider of care, as illustrated in the example of FIG. 2. FIG. 2 is merely one example of a user interface that may be generated in embodiments of the invention, and is not intended as limiting.

A provider or set of providers may be presented with a graphical user interface 200 including task list 206 generated from patient experience data and patient care data on a computer display as illustrated in FIG. 2. Patient name 202 indicates to a care provider for whom tasks 206 need to be completed. Location 204 displays the location of care at which the patient 202 is being treated, which may be used in embodiments of the invention for generating a population of patients and producing a list of tasks 206 to be accomplished, as further discussed below. In some embodiments, a care provider may select a button 222 to see a full list of tasks to be accomplished for the population of patients at that location, possibly prioritized by order of completion.

Task list 206 displays a plurality of tasks 208-220 that have been produced for the patient 202 and prioritized by order of expected completion. In some embodiments, the order of completion is determined based on experience records stored in a server 130 and received at a location of care, such as a long term nursing facility that may be distinct from the location at which the data in the experience records was collected and recorded. The first listed task in the task list 206 is task 208, which may have been prioritized first due to a previously recorded preference of the patient. For example, though the primary goal of a provider's interaction with a patient may be the medication review task 212, a correlation derived from a patient experience record may indicate that the patient focuses better during medication review 212 if it is completed after changing dressings in task 208 and completing a restroom visit in task 210.

Task 208 is presented with an associated time for completion 224 of 14:00, which in some embodiments may be color coded or otherwise formatted to indicate to a care provider the urgency of completion and/or status of the task.

Tasks 210 and 220, as illustrated in FIG. 2, each instruct a care provider to assist a patient in using the restroom. The tasks are scheduled with a periodicity of 2 hours, perhaps due to a recorded comment from a nurse at a previous location of care noting that the patient reported more pain when waiting more than two hours between restroom visits.

In some embodiments, the task list may be prioritized based at least in part on one or more satisfaction scores stored in a patient experience record. Further, as illustrated in step 214 of FIG. 2, in some embodiments additional satisfaction scores may be recorded and added to the patient's experience record during an encounter with a care provider. These new satisfaction scores may be used to reprioritize, update, or otherwise adjust the graphical user interface presented to the care provider. For example, a low satisfaction score input via a tablet computing device by a physical therapist may raise the priority of completing a pain mitigation task 218, while correspondingly lowering priorities of other tasks, such as meal task 216. The adjusted priorities may be presented to the care provider automatically on a graphical display of the tablet, and may present an indication of the cause of the adjustment.

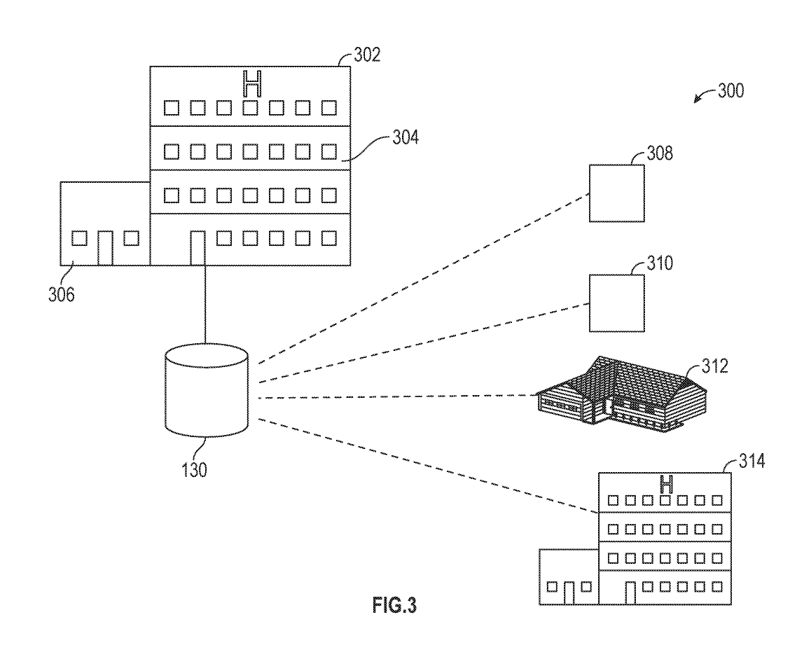

As a further example, consider the case of patient experience data documented on a floor 304 at a first hospital 302, as illustrated in FIG. 3. Patient experience data, including behavioral data such as attitude, choices, and emotional disposition, as well as reported satisfaction scores are recorded during the patient's 3 week stay on floor 304 and stored in the patient's care record on server 130. As the days progress, the care providers on floor, such as nurses, identify care practices, preferences, and quirks that improve the way in which care is provided to the patient, as reflected by a steady increase in the patient's satisfaction score. By the last day, the patient is feeling comfortable and at-home on floor 304.

At the end of the patient's 3-week stay, the patient is transferred to a long-term nursing facility 308 for rest and further recovery. The patient experience data recorded by care providers on floor 304 is crucial for maximum care and satisfaction of the patient at long-term nursing facility 308.

Similarly, the patient care record will be necessary in future visits to locations inside and/or outside the hospital 302 to provide the highest level of care and greatest satisfaction. For instance, after many days spent caring for the patient, nurses on floor 304 may recognize that the patient is more active and reports lower pain scores when the window is opened early in the morning. Access to the patient care record is vital in future health care episodes to recognize this minor task that can have large quality-of-life and/or health benefits without having to rediscover the correlation. Future health care episodes may occur on the same floor 304 at this first hospital 302, a different floor 306, a second hospital 314, a long term nursing facility 308, an outpatient clinic 310, a patient home 312, or any other location where health care may be provided, meaning providers at each of these locations need to be presented with care recommendations based on the patient experience record in server 130.

Returning to the example above, during the patient's stay on floor 304, data relating to patient health, behavior, and satisfaction is collected in a wide variety of ways. Some data may be manually entered by the patient or care provider via a workstation, internet web portal, kiosk, application running on a wireless device, or other manual method. Additionally, data may be pulled automatically from previous electronic medical records or from scanned-in paper records with optical character recognition (OCR). Behavioral data may be recorded directly from electronics including devices, sensors, monitors, and technologies used by a patient to communicate a need or activity either physically (i.e. via push of button, movement, etc.) or physiologically (i.e. from a cardiac or other monitor). Additionally, location and movement data may be extracted from sensors, monitors, and/or other various readers included in a data table.

In embodiments, data may be fed to the system from databases of outside sources such as labs and imaging centers. Further, health and/or behavior data can be collected from wearables, such as a pedometer, activity tracker, blood pressure cuff, or diabetic monitor, illustrated in FIG. 1 as element 140. Such “wearables” may be in the form of an application running on an electronic device worn or carried by the patient, such as a dedicated activity tracker (e.g., a FITBIT or VIVOFIT) or a mobile device, such as a smartphone. Data from wearables may be periodically collected from a web-based cloud.

Additionally or alternatively, data may be transmitted to the system from larger medical appliances such as infusion pumps, ventilators, treadmills, electronic scales, and other health measurement and improvement machines. Embodiments of the invention may be communicatively coupled with and draw data from facility-wide structures, such as nurse call systems, interactive patient beds, and real-time location systems. The above data sources are intended only to be exemplary and are in no way meant to limit the invention. Patient experience acquired by any means from any source may be used in the embodiments of the invention.

Any or all of the patient experience data collected during the patient's stay on floor 304 in hospital 302 may be stored in a patient experience record in server 130 for future use. In embodiments, server 130 may be located in hospital 302, at a remote location, or may comprise a plurality of servers at one or more locations. Patient experience data stored in the patient experience record is relevant and beneficial to the patient's well-being and satisfaction in all future health care episodes, regardless of whether or not those episodes occur on floor 304 of hospital 302.

Patient experience records may additionally or alternatively contain tools that model correlations between the patient's observed health, behavior, and satisfaction. In embodiments of the invention, data collected relating to a patient's health, behaviors, and experiences is analyzed by the system and correlated with observed patient behaviors and/or expressed satisfaction levels to generate tools such as trend maps, priority hierarchies, hot sheets, trigger levels, or compliance scores. These tools may be stored the patient's experience record, such that they may be easily and accurately accessed by providers at all care facilities the patient visits, allowing insights into superior care to follow the patient throughout their entire lives.

Embodiments of the invention may perform statistical analyses to generate the types of tools described. For instance, embodiments of the invention may apply an analysis of a large volume of care and behavioral data points to data collected from the patient's past satisfaction reports to accurately determine which of a set of predetermined prototypes (each of which represents one or more underlying characteristics associated with the patient's medical past that inform the relevant portions of future care) apply to a patient to predict which categories of observed conditions and/or behaviors are likely relevant to improving the patient's future satisfaction.

In an example, a patient in a hospital may have a history of getting out of bed unassisted, even though nurses caring for the patient have repeatedly instructed the patient to notify them of any need, resulting in increased risk of fall incidents. Embodiments of the invention may identify this repeated behavior, apply a prototype of “noncompliant patient” to the patient's record, and cause a warning to be displayed to care providers when instructions for patient movement are recorded or scheduled. A task may be generated at all future locations of care and highly prioritized to discuss mobility with the patient, and to remind the patient not to get out of bed without assistance.

This behavior identification and task prioritization could be in response to a particular calculated score, assigning the patient a designation of a high Fall Risk, allowing the hospital and/or other location of care to predict a need for activating fall protocols for that patient upon each visit or admission. Thus, throughout every visit by this patient, nurses caring for the patient's care will be graphically informed to encourage the patient to visit the bathroom or ask for any possible needs during regular rounding, and are able to closely monitor the patient when she has not been out of bed in a long time.

Embodiments of the invention may additionally recognize that a critical threshold of time, such as 3 hours, has passed since the last time the patient was assisted out of bed, and may warn nurses of a likely need for care, or may move the patient to the top of the nurses' priority lists. This embodiment could send a Fall Risk indication through a bi-directional interface and/or open API structure to an Electronic Medical Record to notate the Fall Risk and prompt the care team to activate all fall protocols (including bed position, socks, and other identifications of fall hazards).

Alternatively or in addition, embodiments of the invention may correlate reported satisfaction data with threshold levels or trends of one or more health parameters. Similarly, embodiments of the invention may correlate reported satisfaction data with threshold levels or trends of one or more reported behaviors of the patient. Any or all of these correlations may take into account data indirectly related to health or behavior data points collected for the patient, such as time of day, date, weather, or visitors.

In a second example, an embodiment of the invention may find that a patient reports increased satisfaction when a nurse rounds on that patient between the hours of 9 and 10 PM during a stay in a first hospital 302. Such a correlation could be due to one last bathroom trip, drink of water, or delivery of medication before the patient naturally chooses to sleep for the night, at around 10:15 PM. The patient, in this case, is made as comfortable as possible just before sleep, which may result in better sleep and a more pleasant morning. This minor timing detail is the type of care that a nurse may have discovered independently after a few days of caring for a patient, but would have to be rediscovered by each nurse and/or each time the patient is transferred to a different care facility, such as second hospital 314. By presenting a recommendation to all nurses to round on the patient at 9:30 PM, embodiments of the invention improve the patient's well-being and overall satisfaction with care provided.

In embodiments, the system may generate a satisfaction score based on weighted values of current and prior health and behavior values, and update this satisfaction score periodically to make providers aware of the patient's likely current level of satisfaction. The score may be generated automatically, based on functions transforming past health and behavior parameters into satisfaction levels, and may update these functions as actual satisfaction data points are collected from the patient. These scores may be presented to providers or patients in any form, including a number, color code, or line graph. In some embodiments, sudden changes in satisfaction score may be used to identify trigger levels of health or behavior parameters, leading to a significant gain or drop in patient satisfaction. Trigger levels may further be partially or wholly based on deviations from average values in a single or across multiple parameters of health and behavior.

In a third example, embodiments of the invention may be able to analyze data collected from an activity monitor and/or treadmill cross-referenced with reported pain scores to indicate to a Physical Therapist that a patient shows the greatest satisfaction level when they walk a total of between 4 and 6 miles in a given day. The Physical Therapist may take this recommendation into consideration when providing her own recommendations to the patient. Further, the therapist may be presented with a graphical, audible, or other warning when the system receives data from an activity monitor indicating that the patient has exceeded 7 miles in a given day, or has failed to walk at least 4 miles for 3 days in a row. The therapist may then contact the patient, inquire if there is a problem, and encourage the patient to stick to the recommended activity level.

Embodiments of the invention may assist a provider in prioritizing care, both to an individual patient and/or across a population of patients requiring care. The invention may prioritize needs of an individual patient based on past correlations among health, behavior, and satisfaction data points, and provide a hierarchy of needs for a patient. The hierarchy may be static or may live-update periodically as data is collected. Additionally or alternatively, embodiments of the invention may prioritize a population of patients for a given provider, or in a portion (or all) of a facility in order of most urgent need of care. Such a prioritization may be presented to a care provider as a heat map or task list of care needed, and may be filtered to reflect a particular care need, such as medication delivery or bathroom assistance.

In a fourth example, an application within an embodiment of the invention may be installed on tablet computers used in a Recovery Department. The application may show all needs for a given patient, and may reorder them based on past extracted correlations between care provided and reported satisfaction levels. Nurses in the Recovery Department may then address needs of patients in an order most likely to produce the most satisfied patients. When a patient is added to or removed from the population of patients in the Recovery Department, the application may automatically reprioritize tasks for the providers, generating a new, adjusted, and/or updated graphical user interface for display.

### Operation of Embodiments of the Invention

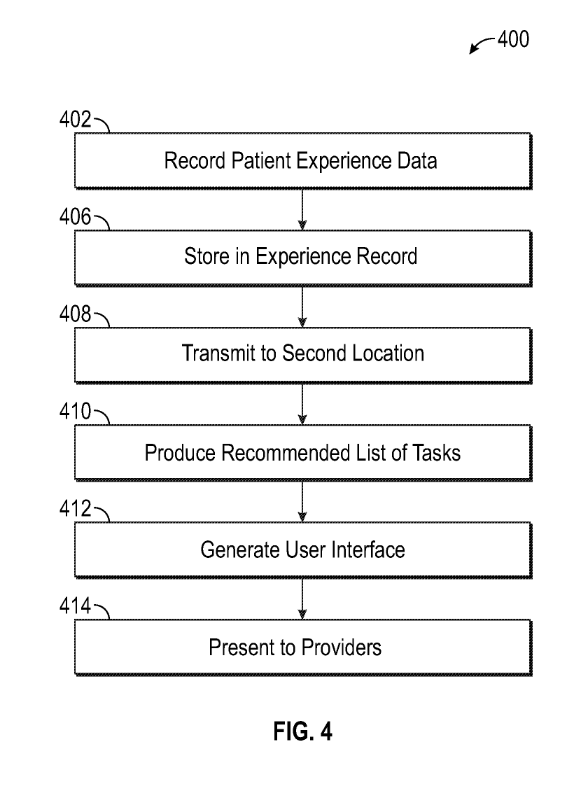

Illustrated in FIG. 4 is a method that may be stored in computer-executable instructions on a non-transitory computer readable medium according to an embodiment of the invention beginning at step 402, in which patient experience data is collected as described above from electronic care devices at a first location of care such as medical appliances, a care provider computing device, wearable monitoring devices, and/or a care facility structure such as a nurse call system. Patient experience data may further include tools such as trend maps, priority hierarchies, hot sheets, trigger levels, or compliance scores generated by a processor 106, as discussed above. In embodiments, the patient experience record includes at least one satisfaction score provided by the patient.

In step 404, the collected and/or generated patient experience data is recorded in a patient experience record linked to the personal identity of the patient on a server 130. The server may be a plurality of servers located at any location, such as a cloud server housed partially or entirely at a non-medical care facility. Particularly, the server 130 may be included in a local network with the electronic care device 140 that collected the patient experience data.

In step 406, experience records for a patient are transmitted to a second location of care, such as a long-term nursing facility 310. This transmission may be in response to a request for transmission from a receiving computer 102, may be performed manually by an electronic transfer command from a computer 102 at the location of care at which the experience data was collected, or may be transferred using transportation of a computer-readable medium. These examples are not intended to be limiting. Any method of transfer of the patient experience record is intended for inclusion in embodiments of the invention.

At step 408, a processor 106 of a computing terminal at the second location of care produces a recommended list of tasks 306 for presentation to one or more providers of care at a second location of care. The second location of care may be a separate location within the same hospital or system as the first location of care. The recommended tasks 306 are based at least in part, on the patient experience record received at the second location of care from the first location of care.

In some embodiments, the list of tasks 306 may be prioritized on a graphical user interface generated in step 410 with expected dates and/or times for completion. Often, the list of tasks 306 includes at least one task recommended to the provider for improving a reported satisfaction score from the patient. In step 412, the generated user interface 200 is presented to a care provider via an electronic display.

The list of tasks 306 may further be based, at least in part, on a care record of the patient containing medical information such as medical history data, physical measurements such as weight or blood pressure, recorded health parameters such as allergies, medication history, physician's notes, conditions, or any other medical data that may be stored in an electronic medical record (EMR). These examples are not intended as limiting. Any data relevant to prior, current, or future care and well-being of a patient recorded at any location may be included as patient care data in embodiments of the invention.

As with the patient experience record, information stored in the care record on server 130 may be produced at the first location of care or other care locations automatically or manually through provider input. The care record of the patient may be transmitted to a computing terminal of the second location of care in response to a request for transmission, manually by electronic transfer from the location of care at which the experience data was collected, or may be transferred using transportation of a computer-readable medium. The care record server on which the patient's care record is stored may be distinct and/or displaced from the experience record server, in embodiments of the invention.

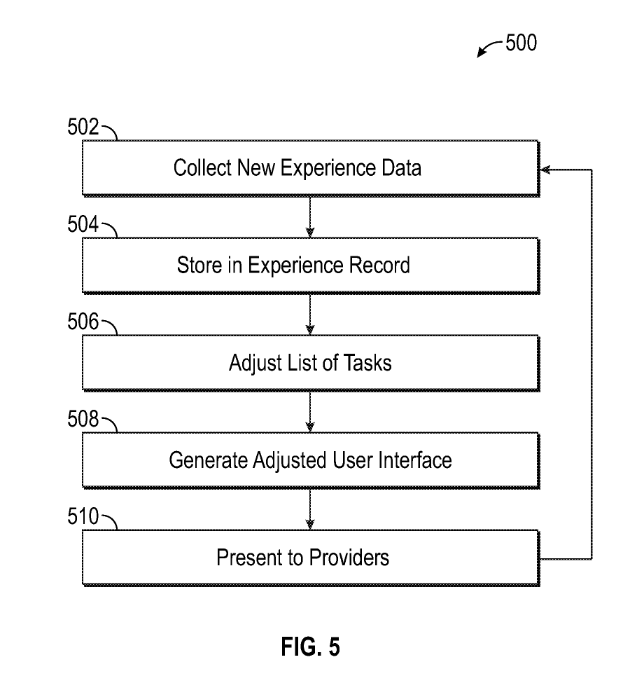

In further embodiments, a graphical user interface 200 may be adjusted based on new, corrected, and/or updated experience data collected and stored into a patient's experience record at a location of care. Steps that may be followed in adjusting a graphical user interface 200 are illustrated as method 500 in FIG. 5, beginning at step 502 in which new experience data is collected for a patient. This experience data may include updated or additional satisfaction scores, corrections to previously stored experience data, additional correlations, extended trends previously documented, or any of the other experiential or behavioral data discussed herein. Data may be collected, as before, automatically by devices or appliances, may be manually input by care providers, patients, or assistants of patients (such as family members), or may be retrieved from other experience records.

In step 506, the new and/or adjusted experience data is stored in the patient's experience record on computing terminal 102 and/or server 130. Thereafter, processor 106 adjusts the list of tasks in step 508. This adjustment may comprise an addition or removal of one or more tasks and/or a reprioritization of task list 306 previously produced. Particularly, a newly documented low satisfaction score provided at a location of care may be used to reprioritize the list of tasks 306 to immediately address an issue causing the low satisfaction score. At step 510, the adjusted graphical user interface is presented to one or more care providers via a display 116.

As discussed above, embodiments of the invention may generate graphical user interfaces presenting recommended care tasks for a plurality of patients, such as an outpatient clinic 310, a hospital department, or a set of patients at a long-term nursing facility 308. In these embodiments, a processor 106 collects patient experience data from a population of patients for generation of a task list 306.

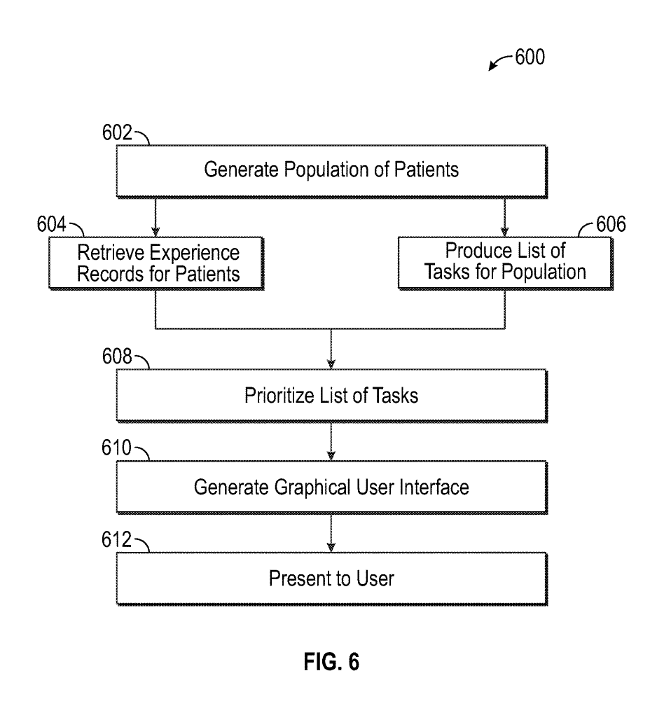

An example of an embodiment producing a graphical user interface of tasks for a population of patients is illustrated in FIG. 6, beginning in step 602 in which a processor 106 of a computing terminal generates a population of patients receiving care. In embodiments, this may be selected based on a location, floor, department, or other attribute of patients. Additionally or alternatively, the population of patients may be generated in step 602 based on a care provider or team of care providers that will be viewing the graphical user interface 200.

In step 604, the experience records for each patient in the population of patients generated in step 602 is retrieved, as detailed previously. In some embodiments, step 604 may be accomplished by transmitting a request to an experience record server 130 including at least a portion of the list of the population of patients generated in step 602. The patient experience records may be requested from a plurality of experience record servers. In other embodiments, one or more of the patient care records may already have been transmitted to the location of care, and may be retrieved in step 604 from a local memory of the computing terminal and/or other local storage.

In step 606, processor 106 produces a list of tasks to be performed by the one or more care providers for the population of patients. As before, the list of tasks may further be produced based at least in part on a care record of one or more of the patients in the population. In some embodiments, one or more tasks in the list of tasks may be correlated with a particular care provider or set of care providers intended to complete the task. The list of tasks 306 is prioritized based at least in part on the retrieved experience records in step 608, as detailed above. In step 610, a graphical user interface for displaying the tasks to the care provider(s) is generated by processor 106, which is then presented on display 118 in step 612.

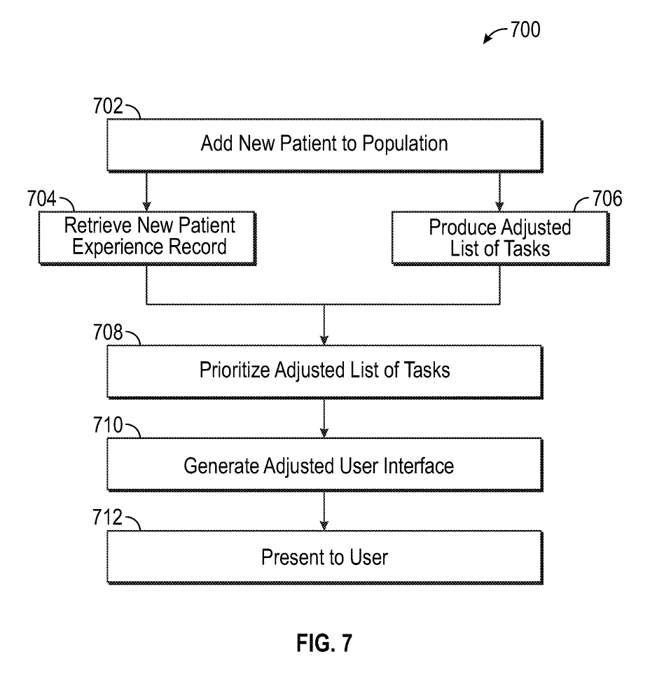

In embodiments, the prioritization displayed on the graphical user interface may be updated based on new or adjusted patient experience and/or care data, as discussed above. Additionally or alternatively, the prioritization displayed on the graphical user interface for a population of patients may be updated when a new patient is added to or removed from the population of patients for care, as illustrated in the example of FIG. 7.

FIG. 7 begins at step 702, in which a patient is added to the population of patients for which a graphical user interface displaying a list of tasks 306 is to be generated. The process 700 will be described for the case in which a patient is added to the population, but can equivalently be applied to situations in which one or more patients are removed from the population of patients.

In step 704, as in step 604 before, the experience records for each patient in the newly adjusted population of patients generated in step 702 is retrieved, which may be accomplished by transmitting a request to an experience record server 130 including at least a portion of the list of the adjusted population of patients generated in step 602. In an embodiment, the request transmitted may include only an indication of the patient added to or removed from the population of patients.

Similarly, in step 706, as in step 606 before, a list of tasks to be performed by the one or more care providers for the adjusted population of patients is produced by processor 106. As before, the list of tasks may be produced based at least in part on a care record of one or more of the patients in the adjusted population, and one or more tasks in the list of tasks may be correlated with a particular care provider or set of care providers intended to complete the task. Specifically in the case of method 700, the adjusted list of tasks 306 is prioritized in step 708 based at least in part on the experience records retrieved in step 704. In step 710, a graphical user interface for displaying the adjusted list of tasks to the care provider(s) is generated by processor 106, which may then be presented on display 118 in step 712.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of generating a graphical user interface based, at least in part, on patient experience data, the method comprising the steps of:
generating a graphical user interface configured to display a recommended list of tasks for a provider at a first location of care,
wherein the list of tasks includes at least one care task to be performed for a first patient,
wherein the graphical user interface is generated based, at least in part, on patient experience data stored in a patient experience record associated with the first patient, and
wherein the patient experience data was recorded in the patient experience record at a second location of care that is distinct from the first location of care.

2. The method of claim 1, wherein the list of tasks is presented in a prioritized order for completion.

3. The method of claim 1, wherein the patient experience record includes at least one satisfaction score provided by the first patient at the second location of care.

4. The method of claim 1, wherein the second location of care is a hospital and wherein the first location of care is selected from a group consisting of a hospital, an outpatient clinic, and a long-term nursing facility.

5. The method of claim 1, wherein the first location of care is a residence of the first patient.

6. The method of claim 1, wherein the graphical user interface is further generated based, at least in part, on patient care data stored in a patient care record associated with the first patient.

7. The system of claim 1, wherein the list of tasks further includes at least one task recommended to the provider for improving a reported satisfaction score from the patient.

8. The system of claim 1, further including the steps of:
collecting a new satisfaction score from the patient;
updating the experience record with the new satisfaction score; and
generating an adjusted graphical user interface configured to display a updated recommended list of tasks for the provider at the first location of care based, at least in part, on the new satisfaction score.

9. The system of claim 1, wherein each task in the recommended list of tasks is presented on the graphical user interface with an associated time for completion of the task.

10. A method of generating a graphical user interface based, at least in part, on patient experience data, the method comprising the steps of:
recording patient experience data at a first location of care in a patient experience record associated with an identity of a patient,
wherein the patient experience record is stored in an experience record server, wherein the patient experience record includes at least one satisfaction score provided by the patient at the first location of care;
transmitting the patient experience record from the experience record server to a computing terminal at a second location of care;
producing a recommended list of tasks for completion by a provider at the second location of care based, at least in part, on the patient experience record; and
generating a user interface configured to display the recommended list of tasks for the provider at a second location of care.

11. The method of claim 10, further including the steps of:
recording patient care data in a patient care record associated with the identity of the patient,
wherein the patient care record is stored in a care record server,
transmitting the patient care record from the care record server to the computing terminal at the second location of care; and
wherein the step of producing the recommended list of tasks for completion by the provider at the second location of care is further based, at least in part, on the patient care record.

12. The method of claim 11, wherein the care record server is distinct from the experience record server.

13. The method of claim 11, wherein the step of recording patient care data in a patient care record is performed at a third location of care that is distinct from the first location of care and the second location of care.

14. The method of claim 10, wherein the patient experience record is transmitted from the experience record server to the computing terminal at a second location of care in response to a request from the second location of care.

15. The method of claim 10, wherein the patient experience record is transmitted from the experience record server to the computing terminal at a second location of care in response to a command from the first location of care.

16. A system for generating a graphical user interface based, at least in part, on patient experience data, the system comprising:
a computer terminal at a first location of care including a processor;
a network interface card; and
a non-transitory computer readable medium storing computer-executable instructions which, when executed by the processor, perform the steps of:
generating a population of patients for care at the first location of care;
retrieving a set of experience records including an experience record for each patient in the population from a plurality of experience record servers,
wherein each experience record in the set of experience records includes an experience datum collected at a location of care distinct from the first location of care;
producing a list of tasks for the population of patients;
prioritizing the list of tasks for the population of patients based at least in part on the set of experience records; and
generating a graphical user interface configured to display the prioritized list of tasks for the population.

17. The method of claim 16, wherein each patient experience record in the set of experience records includes at least one satisfaction score provided by the patient at the distinct location of care.

18. The system of claim 16, wherein the computer-executable instructions further perform the steps of:
adding a new experience datum to an experience record in the set of experience records;
reprioritizing the list of tasks for the population of patients based at least in part on the new experience datum; and
generating a graphical user interface configured to display the reprioritized list of tasks for the population.

19. The system of claim 18, wherein the new experience datum is a new satisfaction score provided at the first location of care by a patient in the population.

20. The system of claim 16, wherein the computer-executable instructions further perform the steps of:
adding a new patient to the population of patients for care at the first location of care;
retrieving a new experience record for the new patient from a new experience record server;
producing an adjusted list of tasks for the population of patients;
prioritizing the adjusted list of tasks for the population of patients based at least in part on the set of experience records and the new experience record; and
generating a graphical user interface configured to display the prioritized adjusted list of tasks for the population.
